(19) United States
(12) Patent Application Publication
(10) Pub. No.: US 2006/0274316 A1
(43) Pub. Date: Dec. 7, 2006

(54) Measuring system for the optical characterization of materials and method for the implementation thereof by said system

(75) Inventor: Stéphane Perquis, Pau (FR)

Correspondence Address: YOUNG & THOMPSON, 745 SOUTH 23RD STREET, 2ND FLOOR, ARLINGTON, VA, 22202, US

(73) Assignee: COLORDIMENSIONS, Pau (FR)

(21) Appl. No.: 10/565,840

(22) PCT Filed: Jul. 15, 2004
(86) PCT No.: PCT/FR04/50339

§ 371 Date: Jan. 26, 2006

(30) Foreign Application Priority Data
Jul. 31, 2003 (FR) 03/09449

(51) Int. Cl. G01N 21/47

(52) U.S. Cl. 356/446

(57) ABSTRACT

The invention relates to a measuring system for the characterization of materials i.e. determination of the optical properties thereof such as brightness, surface aspect, transparency, color (pigments and colorants) and color effects (pearly or metallic). According to the invention, said system comprises an optical sample illumination device (110, 103, 108), an optical device (100) for measuring the light reflected by the sample for treatment by a spectral decomposition device, and a mechanical support structure (300) for the optical measuring device placed above the sample. The optical measuring device (101, 102) comprises a lens formed by several simultaneous measuring points at several angles of the sample.

The invention relates to a measurement system for optical characterization of materials and a measurement process implemented by the system.

Optical characterization of materials is defined as the measurement of visual and optical properties of materials such as brightness, surface condition, transparency, color effects (pigment color, pearly effect, metallic effect) such that the results are expressed in a manner that is the closest possible to the sensations of human vision and most applicable for the manufacturers testing the materials.

Production of materials has developed dramatically in recent years because, to attract the eye of the consumer and to replace traditional uniform colors, designers use all finishing possibilities (shiny, matte and satiny . . . ), juxtaposition of shades (speckled, printed effects . . . ), texture (veined, granitic . . . ) and pigmentary effect (metallic or pearly) at their disposal.

Color manufacturers who encompass all stages of manufacture (from conception of to monitoring the final appearance of the product by passing through the production of pigments and the preparation of materials to intermediate stages) encounter real problems of monitoring, follow-up and communication with the modern materials that they are to reproduce by using existing color measurement equipment. Actually, these professionals use spectrophotometers, because these devices use measurement geometries that have been recommended and accepted by the International Lighting Commission (standard NF x 08-012) for twenty years. Conditions of lighting and measurement of the samples used by the spectrophotometers define the measurement conditions for flat, smooth, opaque, and plain-colored samples. These measurement conditions are no longer suitable for today's material constraints.

Colorimetric results are calculated on the basis of a single insufficient monodirectional measurement that allows neither measurement solely of the color information nor taking into account the effects of the material.

Since 1990 and under pressure from manufacturers of automotive paints, the designers of spectrophotometers have built multiangle instruments that allow spectral analysis of paints with metallic and/or pearly effects at 3 to 7 angles.

Measurements are not complete enough (too little angular information and no axial information) and the associated software does not allow satisfactory exploitation due to the insufficient number of measurement angles.

For some years, there have likewise been instruments that allow measurement of the diffusion envelope of a material; these are profilometers that are also called diffusometers.

These instruments are very comprehensive since they are able to illuminate and measure a point on a material in all directions.

They are not suitable for manufacturers in a production process, however, because: they are too slow (up to 30 minutes per measurement), they allow measurement of only a single point on flat samples, and they are not included in software suitable for the modern colorimetry industry allowing synthesis of all visual characteristics of materials.

Conversely, they are perfectly suitable for the picture industry, simulation of materials and virtual reality representation of objects due to very precise measurement of the diffuse envelope: the BRDF of the materials (bidirectional reflectance distribution function: distribution function of the reflection of a light beam originating from any direction on a sample and analyzed at any angle).

The goal of this invention is to eliminate the drawbacks of the prior art.

The object of this invention is a measurement system for characterization of materials, i.e., determination of their optical properties such as brightness, surface appearance, transparency, color (pigments and dyes) and color effects (pearly or metallic).

More particularly, the object of the invention is a measurement system for optical characterization of a sample of material, comprising an optical device for illumination of the sample, an optical device for measurement of the light reflected by the sample for treatment by a spectral decomposition device (diffraction grating or filter system) essentially characterized in that it comprises the following:
a mechanical support structure of the optical measurement device placed above the sample,
the optical measurement device comprising optics for simultaneous formation of a sample measurement point at several angles, which includes n optical fibers (102), n being strictly greater than two, these fibers being provided on their end with a microlens (101), and being positioned at an equal distance above the sample so as to be oriented in the direction of the sample to collect the light reflected by the sample.

The number n of fibers is advantageously equal to several tens.

In the described embodiment, n is equal to 10.

According to another characteristic, the fibers are distributed at a predetermined distance above the sample in order to define the different measurement angles.

According to another characteristic, the illumination optics comprises a light source and an optical fiber that is provided on its end with a microlens that carries the light emitted by the source, this fiber being supported by the mechanical structure.

According to one alternative to this embodiment, the illumination optics comprises a light source that is placed above the sample that is to be analyzed and that is provided with a lens for focussing on the sample, and being supported by the mechanical structure.

The measurement optics also comprises an optical fiber that is provided on its end with a microlens that is used to calibrate the system, and a fiber that is provided on its end with a microlens that is used to monitor the illumination fiber, these two fibers being located in a sector that is not occupied by the measurement fibers on the mechanical structure.

According to another characteristic, the measurement fibers and monitoring (calibration and illumination) fibers are combined and aligned in a mechanical system of a type such that the set of fibers is positioned facing the entry slit or slits or points of a spectral decomposition device.

The support of the optical device includes a system for moving the illumination fiber above the sample at an angle ranging from 0° to −90°.

According to another structure, the mechanical support structure of the optical measurement device includes at least one arch.

The sample support includes a rotary plate mounted on a sliding and rocking assembly that allows the sample to be raised, lowered, and tilted.

According to another characteristic, the system includes analysis and processing means.

The processing means advantageously include means of automatic control of the mechanical structure.

According to another characteristic, the analysis means comprise a spectral decomposition device and a matrix sensor of the scientific video camera type.

The object of the invention is likewise a measurement process for optical characterization implemented by the system that was just described, consisting in the following:
illuminating the sample at a given angle,
acquiring a first measurement series by means of optical fibers simultaneously routing the light reflected by the sample at angles defined by their respective positions relative to the sample,
acquiring several other measurement series by having the sample or the optical measurement device rotate relative to a measurement axis that passes through the central measurement point of the sample as far as one complete rotation with a predetermined increment of the value, the process thus making it possible to obtain the measurement of the information of colored reflection in all predetermined directions and taking into account effects of the material.

Other particular features and advantages of the invention will become apparent by reading the following description that is given by way of a nonlimiting example and with respect to the drawings in which:

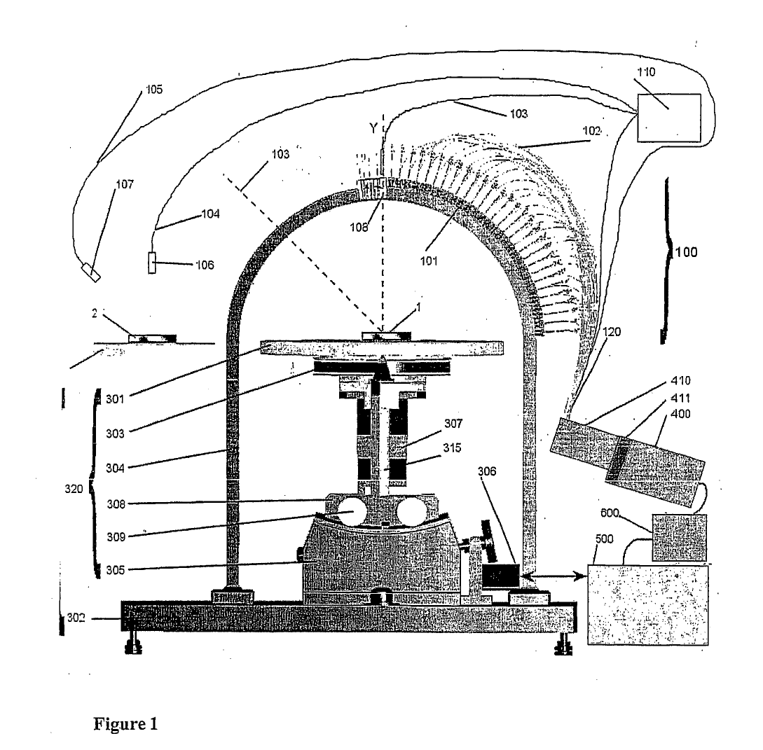

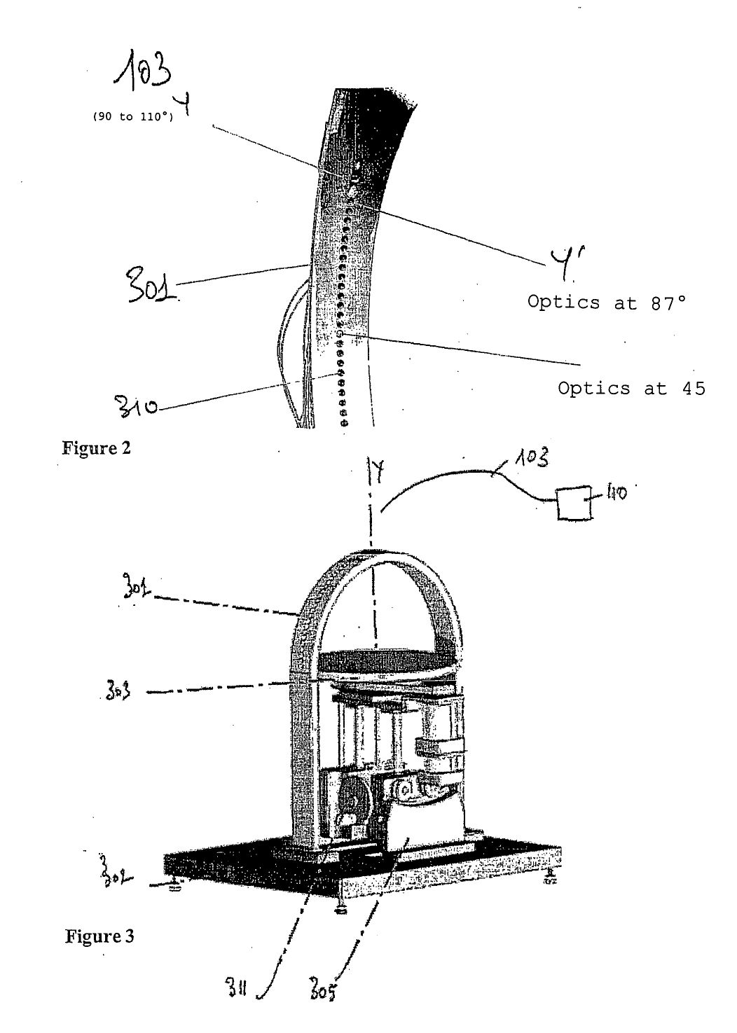

FIG. 1 shows a diagram of a general view of the system according to the invention, FIG. 2A shows a partial diagram of the arch 301,

FIG. 2B shows one variant embodiment for the display optics,

FIG. 3 shows a perspective diagram of the system according to the invention,

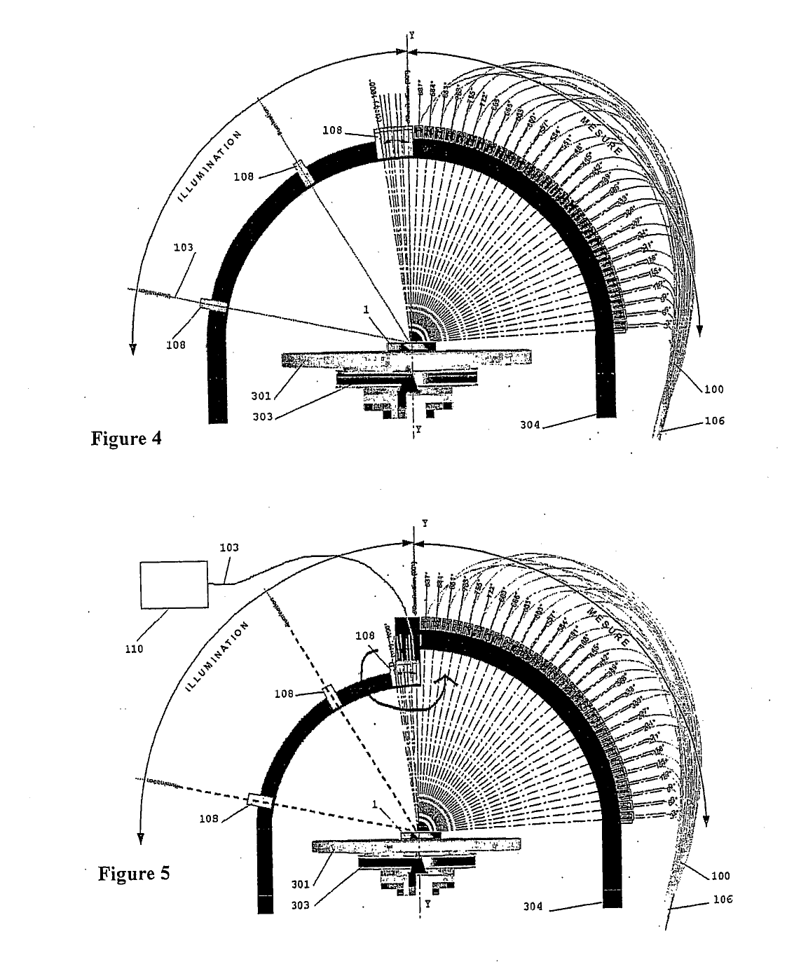

FIG. 4 shows a diagram of the illumination and measurement device according to a first embodiment,

FIG. 5 shows a diagram of the illumination and measurement device according to a second embodiment,

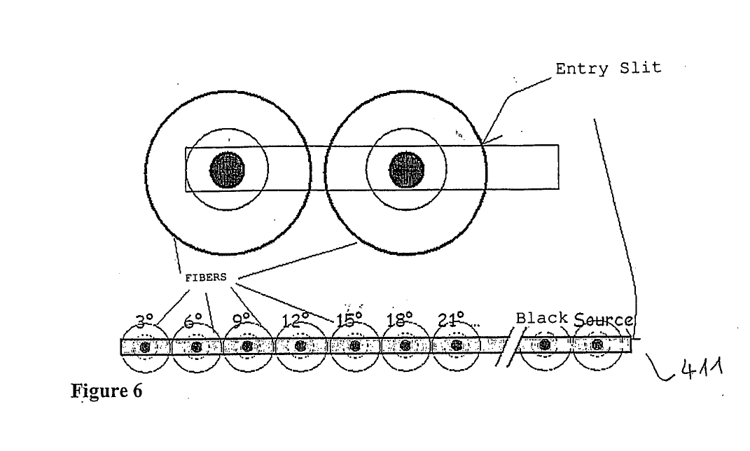

FIG. 6 shows a diagram illustrating the light flux carried by the fibers ending on the entry slit of a spectral decomposition device.

The system according to the invention comprises two operating groups for measurement per se and one operating group for signal processing and optionally control of the group, this control also possibly being manual.

As illustrated by the diagram in FIG. 1, the system comprises the following:

1)—an optical device 100 comprising measurement optics 101, 102, sample illumination optics 103, a calibration device 104, 106, and a device for monitoring the illumination optics 105, 107.

2)—a mechanical support structure 300 comprising a support of the optical device 301 and a sample support 320: 302-305.

3) means of analysis 400, 600 and processing 500 of the information extracted from the light fluxes carried by the optical device.

Each of these groups will now be presented in detail. Reference can be made to any of the diagrams of FIGS. 1, 2, 2B and 3 for better understanding.

The optical measurement device includes a set of microlenses 101 and optical fibers 102 for measurements. Each microlens 101 is connected to a fiber 102 so as to analyze the reflection of the sample at a very exact angle without parasitic reflections originating from other angles disrupting the analysis. The use of n fibers provided with microlenses allows n simultaneous angular measurements. The fibers 102 are designed to simultaneously carry the light reflected by the sample at several angles toward a spectral decomposition device.

In the given embodiment, the optical measurement device is composed of 28 optical fibers, of 2 fibers for calibration of the measurement in transmission and of lateral diffusion, and of one brightness measurement fiber 107 placed on the axis of illumination.

The illumination device comprises two fibers 103, 104 that are provided with one lens on the end 106 and 108, and one fiber 105.

The sample is illuminated by, for example, the fiber 103 that is used to carry the light provided by a source 110, connected on the other end to a microlens 108. This fiber and the associated microlens can be identical to the measurement fibers.

The light-carrying fiber is placed vertically above the sample and can be moved from 0 to −90° above the latter.

The second fiber 104 is used for calibration of the system and carries the light from the source through a fiber and a microlens 106 that are identical to the measurement fibers. The microlens of this fiber is placed outside the measurement enclosure and illuminates a white, diffusing calibration tile. These fibers are above a calibration standard 2 placed on a support 3.

The third fiber 105 is used to directly monitor the state of the illumination source simultaneously with the measurements. It is this value that is used to calibrate the set of measurements.

The measurement fibers and the illumination fiber 105 are combined in a cable 120 that is connected by a connector 410 to a spectral decomposition device that is connected to a matrix sensor of the scientific video camera type 600 so that the collected light is analyzed and processed by the processing unit 500 to which a matrix sensor of the scientific video camera type is connected.

The illumination device, in one variant embodiment shown in FIG. 2B, can be produced by an optical system comprising an illumination source 111, an optical assembly for convection 112 of the light beam toward the sample and a mirror 113 that allows simultaneous measurement of the quality of the source (fiber 105) and the light reflected by the sample (fiber 104).

Such a variant allows greater illumination of the sample with a less powerful source. This system can be mounted directly on the support structure, as shown in FIG. 2B.

The mechanical structure 300 makes it possible to provide a support function of the assembly, but also movements, in particular the movement of the sample support.

In one embodiment, the support device of the optics is produced by a curved arch 301 that is perforated with n holes, or 28 holes, for the measurement fibers in the given example. It likewise comprises several holes 200 for the illumination fiber including one main hole 200 in the main axis of illumination Y that allows movement of the source from 0° to −10° every 1°, as is apparent in the detail of FIG. 2A.

In the particular embodiment that is given, the arch is curved over 255 mm and is 550 mm high and 300 mm wide; it is fixed on the base of the mechanical structure and can be detached.

The arch 301 is designed so as to support aiming of the microlenses on the end of the fibers at the measured location of the sample 1. The dimensions and curving of the arch are chosen according to the samples and the desired angular resolution.

The sample support 300 is motorized, control of the motor is done by electronics 306 integrated into the support, advantageously controlled by the processing and control unit 500.

The sample support comprises a rotary plate 303. The control of the movements of the plate is programmed, for example, to have a precision of 0.01 mm relative to the optical part and to have prompt startup of angular measurements every n degrees of axis.

The rotating plate 303 is driven by a belt 304 that is connected to a motor 307.

The flat samples or those always having the same shape are positioned on a template placed on the rotary plate so that their surface is horizontal and positioned at the point of convergence of the measurement beams and the illumination beam.

The mechanical device 305, 308, 309 under the plate is designed to take up the thickness and tilt of the samples of variable shape and dimensions and to allow the measurement point to be placed exactly under the optical device at the point of convergence of the measurement beams and the illumination beam.

The mechanical device comprises a sample levelling mechanism that includes two support axes 315 on which the plate slides while the plate and motor assembly are being raised and lowered, driven, for example, manually by a pulley 310.

The mechanical device under the plate, moreover, includes two “bananas” 305 on which there rests the assembly composed of the plate, motor, and the raising/lowering mechanism that is placed at ±10° by a handwheel 311. This assembly makes it possible to obtain ±10° balancing of the samples relative to the measurement point.

The mechanical structure 300 likewise comprises a base 302 that supports the sample positioning mechanism 320 and the arch whose curve begins above the ‘zero’ measurement level of the plate.

In the practical embodiment, the base exhibits a sturdiness that makes it possible to avoid any dimensional variation and that supports samples weighing more than 20 kg.

In the practical embodiment, the mechanical structure 300 is scored with grooves under the plate every 1° of axis and is coupled to detection optics located under the plate, allowing synchronization of the axial position of the sample with the lighting source and a matrix sensor of the scientific video camera type. The use of these grooves makes it possible to use a continuous motor while allowing synchronization of the axial positioning.

The processing unit is produced, for example, by a PC-type computer or by processing electronics placed after the matrix sensor of the scientific video camera type, comprising a program that executes the sequence of movements, this program being able to include parameters selected by the operator according to the nature of the sample to be characterized and the desired precision of the movements of the sample support.

According to one embodiment leading to a reduction of system costs, the arch 301 is made from a single piece, as is the case in the diagrams of FIGS. 1 and 3.

In this case, this arch comprises one measurement side 301 and one illumination side 201. FIG. 4 shows this configuration. The arch takes measurements on the same axis as the illumination, yielding better results for colorimetry than those obtained with classic systems.

Another approach illustrated by the diagram of FIG. 5 can consist in making a mechanical support of the optical device in two separate parts in which only the measurement part 301 (axis Z) of the illumination part 201 is on the arch. This allows the illumination to be positioned in any direction and the variations of shade of the materials to be measured as a function of the position of the lighting.

The measurement part is set up in the same way as on the arch that was described above, but is cut off from the illumination part: the arch forms nothing more than a half-arch.

The illumination part can be placed equally under or over the measurement part. In the practical embodiment, the illumination part is connected to the measurement part above the center of the plate and works in the same way as the illumination part shown in FIG. 4 since the source moves from 0 to −90° as it moves along the arch. The illumination part can be positioned in any of the axes and the combination with the angular movement of the source, and allows illumination virtually in all directions.

In one preferred embodiment, lenses mounted on the ends of the fibers with a sighting precision of 0.1 mm are chosen. This means that any light beam reaching the microlens with an angle of greater than 0.1° is not taken into account. Due to this feature, it is possible to measure curved objects without the different parts of the object or parasitic reflection influencing the measurement.

The operation of the measurement system according to this invention will now be presented in detail.

The sample to be analyzed is placed in the center of the plate that is controlled in height and tilt so that its surface is positioned exactly horizontally to the point of convergence of the measurement beams and the illumination beam. The positioning can be controlled either manually or assisted by an optical system and managed automatically by the computer to allow perfect repeatability of repositioning of the samples.

During each acquisition and simultaneously with angular measurements, the intensity and spectral value of the source are measured using the measurement fibers of the source and after processing by the spectral decomposition device and acquisition by the matrix sensor of the scientific video camera type. This spectral value of the source is the reference for the computation of the fluxes reflected by the sample toward the various optics at predefined angles.

Monitoring calibration is done simultaneously to verify the possible processing errors. The processing unit controls the calibration and measurement sequence. The calibration sequence is implemented on a metallic standard 2 that is provided for this purpose.

The optical lenses are positioned on the arch equidistantly and, for example, at 25 cm from the sample, every 3° of angle with an angular precision of greater than 2 minutes of angle (0.06 mm).

It is possible to increase the precision of the system by positioning the optics on a larger arch. In this case, identical spacing between the microlenses allows angular measurements to be taken every degree of angle.

During each acquisition, the light reflected by the sample is routed simultaneously by the 24 optical measurement fibers that point in front of the entry slit of a spectral decomposition device.

The connection between the fibers and the spectral decomposition device is made by a positioning connector 410 on the mount of the spectral decomposition device 400.

The measurement and monitoring data arrive simultaneously at the slit as shown in the diagram of FIG. 6.

A high quality picture contains all of the angular spectral data of the measured sample. The measurement time is very short (from 3 to 0.1 seconds), and processing is almost instantaneous. The picture is converted into spectra (at bottom right, a section of the picture at 550 nm), protected as a function of the absolute axis and the calculated axis of sample positioning.

One complete measurement is taken after complete rotation of the plate. The multispectral data file obtained following this complete measurement then contains all of the spectral values of the sample at all the measured angles and following all the axes.

The system that has just been described makes it possible to define the colorimetric quality of the material (existing values and new functions and indices), the brightness (specular representation), and to translate the texture effects into information on the variation of tonality and brightness.

With computer-controlled and motorized management of the angle of illumination, of rotation and tilt of the sample, information is recovered that makes it possible to demonstrate variations of shade and reflection of the material measured with great precision and perfect repeatability.

When illumination is carried out at 0° to the perpendicular of the sample, this measurement geometry resembles spot illumination at 0° and a diffuse measurement (in the upper hemisphere only). The sum of the measured spectral values makes it possible to find a value near the spectral measurement values in normalized 0°/diffuse geometry.

By shifting the illumination point from 0° to −10° every n degrees, the angular displacement of the source generates different measurement angles relative to the reflective axis (axis of reflection of the brightness); this allows an increase in the number of measurement references and the angular resolution. One complete measurement with an angular resolution of one degree and one measurement every degree of axis can take 30 to 90 seconds.

After processing by the spectral decomposition device by the matrix sensor of the scientific video camera type and by a PC-type computer or by processing electronics placed after the matrix sensor, the multispectral values thus obtained provide all of the information on brightness, surface condition, and color that is necessary as a function of the observation angle.

When the structure of the surface or the texture of the samples so requires, acquisitions will be made in several passes to refine the measurement resolution in certain axes and certain angles.

In order for the measurements to be reliable and fast, only the values important for the calculations and graphic representations will be retained.

1. Measurement system for optical characterization of a sample of material, comprising an optical device for illumination of the sample, an optical device for measurement of the light reflected by the sample for processing by a spectral decomposition device, characterized in that it comprises the following:
a mechanical support structure (300) of the optical measurement device placed above the sample,
and in that the optical measurement device (100) comprises optics (101, 102) for simultaneous formation of spectral measurement points at several angles of the sample (1), comprising n₂₀ optical fibers (102), n being strictly greater than two, these fibers being provided on their end with a microlens (101), and being positioned at an equal distance above the sample so as to be oriented in the direction of the sample to collect the light reflected by the sample.

2. Measurement system for optical characterization of a sample according to claim 1, wherein n is equal to several tens, the fibers being distributed at a predetermined distance above the sample (1) on a predetermined opening sector α so as define the different measurement angles.

3. Measurement system for optical characterization of a sample according to claim 1, wherein the illumination optics (110 or 111) comprises a light source (110) placed above the sample (1) and optionally, if necessary, an optical fiber (103) that is provided on its end with a microlens (108) that carries the light emitted by the source, this fiber being supported by the mechanical structure.

4. Measurement system for optical characterization of a sample claim 1, wherein the measurement optics (100), moreover, comprises an optical fiber (104) that is provided on its end with a microlens that is used to calibrate the system and that is located in a sector that is not occupied by the measurement fibers on the mechanical structure, and a fiber (105) that is used to monitor the illumination source and that is joined on its end to measurement fibers in a cable 120 connected to a diffraction system.

5. Measurement system for optical characterization of a sample claim 1, wherein the support structure (300) comprises means (200 or 201) for allowing movement of the illumination optics above the sample at an angle ranging from 0° to −90°.

6. Measurement system for optical characterization of a sample according to claim 1, wherein the mechanical support structure of the optical measurement device includes at least one arch (301).

7. Measurement system for optical characterization of a sample according to claim 1, wherein the sample support includes a rotary plate (303) mounted on a sliding and rocking assembly (315, 305, 308, 309) that allows the sample to be raised, lowered, and tilted.

8. Measurement system for optical characterization of a sample according to claim 1, wherein it includes analysis and processing means (400, 500, 600).

9. Measurement system for optical characterization of a sample according to claim 7, wherein the processing means (500) include means of automatic control of the mechanical structure.

10. Measurement system for optical characterization of a sample according to claim 7, wherein the analysis means comprise a spectral decomposition device (400) and a matrix sensor of the scientific video camera type (600).

11. Process of measurement for optical characterization of a sample, comprising the following steps:
illuminating the sample at a given angle,
acquiring a first measurement series by means of optical fibers simultaneously routing the light reflected by the sample at an angle defined by their respective positions relative to the sample,
acquiring several other measurement series by having the sample or the optical measurement device rotate as far as one complete rotation with a predetermined increment of value.

12. Measurement system for optical characterization of a sample according to claim 2, wherein the illumination optics (110 or 111) comprises a light source (110) placed above the sample (1) and optionally, if necessary, an optical fiber (103) that is provided on its end with a microlens (108) that carries the light emitted by the source, this fiber being supported by the mechanical structure.

13. Measurement system for optical characterization of a sample claim 2, wherein the measurement optics (100), moreover, comprises an optical fiber (104) that is provided on its end with a microlens that is used to calibrate the system and that is located in a sector that is not occupied by the measurement fibers on the mechanical structure, and a fiber (105) that is used to monitor the illumination source and that is joined on its end to measurement fibers in a cable 120 connected to a diffraction system.

14. Measurement system for optical characterization of a sample claim 3, wherein the measurement optics (100), moreover, comprises an optical fiber (104) that is provided on its end with a microlens that is used to calibrate the system and that is located in a sector that is not occupied by the measurement fibers on the mechanical structure, and a fiber (105) that is used to monitor the illumination source and that is joined on its end to measurement fibers in a cable 120 connected to a diffraction system.

15. Measurement system for optical characterization of a sample claim 2, wherein the support structure (300) comprises means (200 or 201) for allowing movement of the illumination optics above the sample at an angle ranging from 0° to −90°.

16. Measurement system for optical characterization of a sample claim 3, wherein the support structure (300) comprises means (200 or 201) for allowing movement of the illumination optics above the sample at an angle ranging from 0° to −90°.

17. Measurement system for optical characterization of a sample claim 4, wherein the support structure (300) comprises means (200 or 201) for allowing movement of the illumination optics above the sample at an angle ranging from 0° to −90°.

18. Measurement system for optical characterization of a sample according to claim 2, wherein the mechanical support structure of the optical measurement device includes at least one arch (301).

19. Measurement system for optical characterization of a sample according to claim 2, wherein the sample support includes a rotary plate (303) mounted on a sliding and rocking assembly (315, 305, 308, 309) that allows the sample to be raised, lowered, and tilted

20. Measurement system for optical characterization of a sample according to claim 2, wherein it includes analysis and processing means (400, 500, 600).
